(19) United States
(12) Patent Application Publication
(10) Pub. No.: US 2002/0022969 A1
(43) Pub. Date: Feb. 21, 2002

(54) Remote automated customer support for manufacturing equipment

(76) Inventors: Marc van den Berg, Saratoga, CA (US); Jay Jung, Sunnyvale, CA (US); Toan Nguyen, San Jose, CA (US)

Correspondence Address: FLEHR HOHBACH TEST, ALBRITTON & HERBERT LLP, Suite 3400, Four embarcadero Center, San Francisco, CA, 94111, US

(21) Appl. No.: 09/894,221

(22) Filed: Jun. 27, 2001

Related U.S. Application Data
(60) Provisional application No. 60/216,783, filed on Jul. 7, 2000.

(51) Int. Cl. G06F 17/60

(52) U.S. Cl. 705/1

(57) ABSTRACT

A system, methods, and computer readable medium for providing automated customer support of semiconductor manufacturing equipment is disclosed. Sensors attached to the semiconductor manufacturing equipment can be monitored by either an automated program or a service technician to detect alarm conditions. Upon detection of an alarm condition, a remotely located customer support system can be contacted and provided with key values indicating the nature of the alarm condition. The remotely located customer support system can use the key values to query a database for electronic text files containing instructions for a service technician to follow when taking corrective action to resolve the alarm condition. When an electronic text file is found to be associated with the key value in the database, the electronic text file is transmitted to a service technician who services the manufacturing equipment at the customer site. In the case that no matches are found, the alarm condition can be reported to a troubleshooting engineer who can resolve problem creating the alarm condition, draft a solution in the form of an electronic text file, and create an entry in the database linking the new text file with the key value.

### RELATED APPLICATIONS

This application claims priority to and incorporates by reference in its entirety provisional patent application entitled Remote Automated Customer Support for Manufacturing Equipment, Ser. No. 60/216,783, filed Jul. 7, 2000, with the United States Patent and Trademark Office.

### FIELD OF THE INVENTION

The present invention relates to automated customer service for manufacturing equipment. More particularly, the present invention relates to a system and method for providing remote, automated customer support to users of semiconductor manufacturing or fabrication equipment.

### BACKGROUND OF THE INVENTION

Manufacturers of sophisticated semiconductor chips continuously seek to increase productivity through the automation of the manufacturing process. Automation of the process control of equipment has permitted the control of ever increasing numbers of process variables and process steps, thereby increasing overall production efficiency. In some cases, such as in the manufacture of semiconductor chips, automated process control has enabled efficient mass production of the products.

Semiconductor manufacture requires a high degree of monitoring and control of many pieces of equipment and countless process steps. In highly automated manufacturing systems, if there is a problem with the equipment or process, an alarm condition may result. An alarm condition usually requires the attention of a service technician. The service technician may consult technical manuals and the like in an attempt to identify and resolve the problem that created the alarm condition. Often times the service technician makes a call to the equipment manufacturer for assistance in solving the problem. Because of the high demand for production time in semiconductor fabrication facilities (“fabs”), the fabs are often operated 24 hours per day, seven days per week. Thus, the equipment manufacturer needs to hire and train experts to receive and respond to the calls. As will be recognized, it is costly for the equipment manufacturer to provide 24-hour, in-person expert help. Additionally, economic pressures and/or unavailability of qualified engineers can lead to under staffing of the technical support response lines. In the end, the service technician (the customer) is left waiting on the telephone, or leaving a message for a return call, which ultimately leads to costly down time and customer dissatisfaction.

Thus, there is a need to reduce an equipment manufacturer's staffing needs for its customer support response lines and to reduce the response time from the equipment manufacturer to the equipment user.

### SUMMARY OF THE INVENTION

Accordingly the present invention provides a system and method for remote, automated customer support to end users of manufacturing equipment. In particular, the present invention automates the service of customer or technical support to end users of manufacturing equipment, comprising the following steps: equipment data representative of one or more manufacturing equipment units is received from a supervisory control and data acquisition system (SCADA). The SCADA is in electronic communication with the one or more manufacturing equipment units. Next, from the equipment data, it is determined whether an alarm condition has occurred with at least one of the manufacturing equipment units. If an alarm condition has occurred, an electronic message is sent to the end user. The electronic message includes at least one possible solution or course of corrective action in response to the alarm condition.

In another aspect of the present invention, a system is provided wherein once the equipment data indicates that an alarm condition has occurred, a corrective action database is provided, wherein the corrective action database has a plurality of records having searchable data fields that correspond to previously experienced alarm conditions and/or equipment unit problems. Each of the records points to an electronic text file that describes corrective action that may resolve the previously experienced alarm conditions and/or equipment unit problems. The system locates one or more electronic text files to remedy the alarm condition and/or problem from the corrective action database by comparing the equipment data to the plurality of records. Once identified, the electronic text file describing the possible corrective action is electronically transmitted to the service technician.

In yet another aspect of the present invention, a method of conducting business is provided characterized in that equipment data, representative of the operation and use of manufacturing equipment units by a customer at a remote customer site is collected, monitored and stored by the manufacturer of the equipment at the manufacturers site, and selected information responsive to the equipment data is automatically transmitted to the customer by the manufacturer.

In yet another aspect of the present invention, a computer program product is provided that contains instructions that, when executed by a computer, provide technical support to a service technician, by

receiving an alarm condition in the form of an electronic message, the electronic message including at least one key value associated with the alarm condition;

extracting the key value from the received message; querying a database containing electronic text files using the extracted key value; retrieving an electronic text file associated with a matching key value; and transmitting the electronic text file to the service technician as well as other customers in the form of an email message.

The present invention meets these needs, thus more efficiently utilizing human resources, reducing servicing costs, and reducing the response time from the equipment manufacturer to the equipment user to fix the problem. In summary, the present invention provides a system and method for automatically transmitting to a customer, preferably by email, corrective action information responsive to data regarding the operation of equipment. Further, the present invention provides the manufacturer of the equipment with access to real time data regarding the operation and use of the equipment by its customers. Access to such data provides a very powerful tool. For example, in addition to providing the corrective action function, the data can be further analyzed. The data can then be used to troubleshoot difficult problems. Historical trends of the operation of the equipment can be developed. Statistical analysis can be performed. The need for preventative maintenance can be predicted, and such predictions are based on real usage of the equipment as opposed to general time schedules.

### BRIEF DESCRIPTION OF THE DRAWINGS

Other objects and advantages of the present invention will become apparent upon reading the detailed description of the invention and the appended claims provided below, and upon reference to the drawings, in which:

FIG. 1 is an illustration in block diagram form of an embodiment of the system architecture of the present invention;

FIG. 2 is a drawing illustrating in block diagram form an embodiment of the customer database;

FIG. 3 is a flow chart of an embodiment of the method of the present invention according to one embodiment of the present invention;

FIG. 4 is a flow chart showing the method of the present invention according to another embodiment of the present invention;

FIG. 5 is an illustration in block diagram form of an alternative embodiment of the system architecture of the present invention;

FIG. 6 is a flow chart showing an alternative embodiment of the method of the present invention;

FIG. 7 is a flow chart showing an alternative embodiment of the method of the present invention;

FIG. 8 is a flow chart showing an alternative embodiment of the method of the present invention; and

FIG. 9 is an illustration in block diagram form illustrating an alternative embodiment of a database as utilized by embodiments of the present invention.

### DETAILED DESCRIPTION OF THE PREFERRED EMBODIMENTS

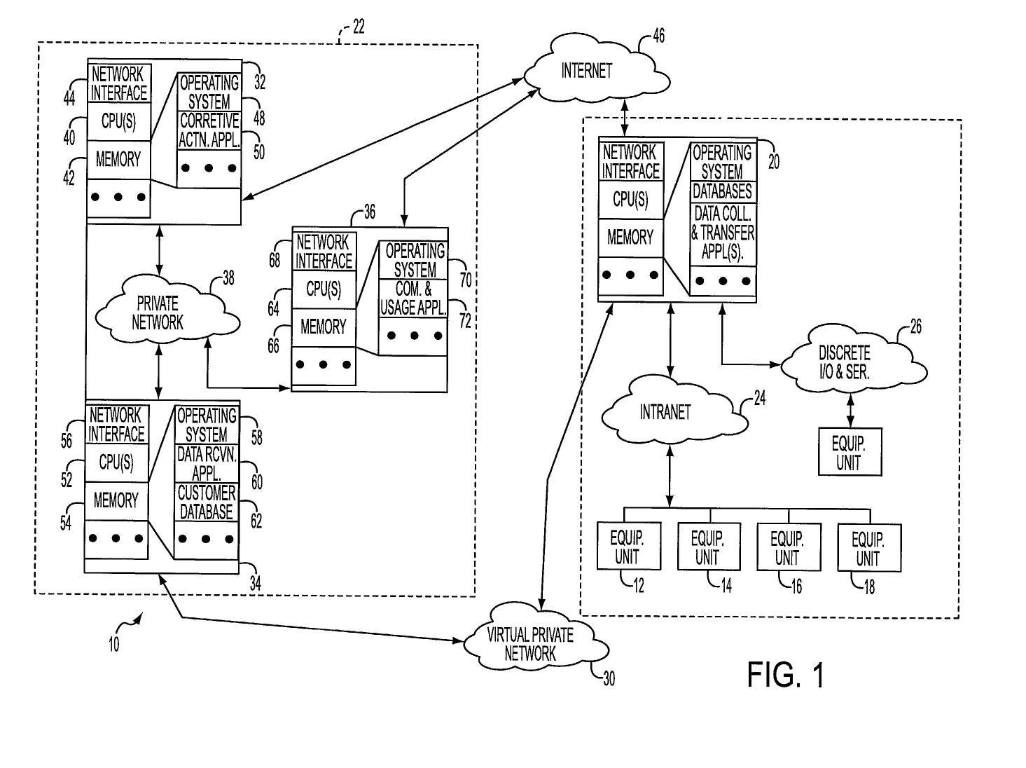

Referring to FIG. 1, system 10, in accordance with an embodiment of the present invention, is provided for automating the receiving of, the processing of, and the responding to customers' equipment maintenance needs. System 10 includes one or more manufacturing equipment units such as equipment units 12, 14, 16 and 18 (such as Trackmate™, Bulkmate™, Miniwastmate™, Wastemate™, and EnChem™ all manufactured by Microbar Inc.), supervisory control and data acquisition system 20 (“SCADA”) which includes supervisory control and data acquisition (SCADA) software such as that provided by Fix™ produced by Intellution, ChemManager™ by Microbar, Inc., or IndustrialSQL™ by Wonderware, Inc. for example, and the remotely located equipment manufacturer or OEM customer support center 22.

In general, the present invention provides a system and method for remote, automated customer support to end users of manufacturing equipment. In particular, the present invention automates the service of customer or technical support to end users of manufacturing equipment, comprising the following steps: The SCADA 20 is in electronic communication with sensors attached to the one or more manufacturing equipment units 12, 14, 16, 18, and 19. Equipment data, representative of one or more manufacturing equipment units, is collected by the sensors and communicated to the SCADA 20. The equipment data is received at the support center 22 from SCADA 20. Next, from the equipment data, it is determined whether an alarm condition has occurred with at least one of the manufacturing equipment units. The alarm condition can be detected by either the SCADA 20 or the support center 22, depending on the nature of the equipment data. Alarm conditions can represent equipment failure, the need for preventative maintenance, a process anomaly, and the like. Alarm conditions generally indicate the need for some sort of corrective action to be taken. If an alarm condition has occurred, an electronic message is sent to a service technician responsible for servicing the equipment 12, 14 16, 18 and 19. The electronic message includes at least one possible solution or course of corrective action in response to the alarm condition. The SCADA system 20 sends data received from the equipment in real time to customer support center 22 over a communications network, preferably high bandwidth virtual private network 30. A virtual private and high bandwidth communication link is preferred because of the amount of data being transmitted. As more fully described below, customer support center 22, among other things, receives, stores, and analyzes the real time data from SCADA system 20 to identify and respond to problems occurring in real time at the production line. In response to the problems, customer support center 22 identifies and electronically transmits possible solution(s) to the problem.

Specifically, the SCADA system 20 communicates with and/or receives data from equipment units 12, 14, 16, 18, and 19 preferably through communication channel 24, although an individual equipment unit 26 may communicate via discrete input/output and serial ports 28. Communication channel 24 can be a virtual private network connection, intranet, dedicated telephone line, regular packet switched telephone network connection, or other telephonic medium desired by the manufacturer.

Each equipment unit typically uses local feedback verification algorithms to set the alarm condition for limit variables, e.g., equipment usage (total pump running time, number of valve switches, and the like) and/or process variables (temperature, pH and the like). The skilled artisan will recognize that many different configurations, other than those presented herein, can be used to set the alarm condition for the many number of variables monitored in a manufacturing process. For example, SCADA system 20 could perform the feedback verification algorithm rather than the individual equipment unit. Further, those skilled in the art will recognize that many different types of equipment and any number of equipment units may make up the equipment units 12, 14, 16 and 18.

Customer support center 22 preferably has three systems, web server 32, data manager 34, and enterprise resource planning server 36 (ERP), all of which are interconnected through private network 38 (an ethernet for example). Alternatively, the ERP 36 may be omitted from the customer support center 22. The three systems, 32, 34 and 36 preferably communicate using structured query language protocol. The skilled artisan will recognize that less or more than three systems may be used, that different communications protocols may be used, and that other communications networks may be used without exceeding the scope of the present invention.

Web server 32 may include CPU(s) 40; memory 42; and network interface 44 for communicating over private network 38 and over public computer network 46.

Memory 42 may include operating system 48 (such as Windows NT™ or MacOS™ for example); and corrective action application or database 50, embodied in a software module having instructions for identifying and providing responses to alarm conditions in real time. The corrective action application or database preferably includes a plurality of records having searchable data fields corresponding to previously experienced equipment problems and wherein each record points to an electronic memo describing possible solutions for how to resolve the previously experienced problems.

Data manager 34 may include CPU(S) 52; memory 54: and network interface 56, for communicating over private network 38 and over virtual private network 30.

Memory 54 may include operating system 58 (such as Windows NT™ or MacOS™ for example); data receiving application 60, which represents a software module having instructions for receiving and storing data from SCADA system 20 (preferably this would be IndustrialSQL™ by Wonderware, Inc.); and customer database 62, which contains entries for each customer being served.

Enterprise resource planning server 36 (“ERP”) may include CPU(s) 64; memory 66; and network interface 68 for communicating over private network 38 and over internet 46.

Memory 66 may include operating system 70 (such as Windows NT™ or MacOS™ for example); and commodity and usage status application 72, which represents a software module having instructions for identifying and responding to low commodity and/or preventative maintenance situations.

Data receiving application 60 of data manager 34, receives real time data from SCADA system 20 and stores the data in customer database 62. It will be recognized by the skilled artisan that data manager 34 may receive data from more than one SCADA system. For example, data managers can receive data from two or more SCADA systems each located at a different customer site. Thus, more than one customer may be served by a single data manager 34.

In another aspect of the present invention, a system is provided wherein once the equipment data indicates that an alarm condition has occurred, a corrective action database is provided, wherein the corrective action database has a plurality of records having searchable data fields that correspond to previously experienced alarm conditions and/or equipment unit problems. Each of the records points to an electronic memo that describes how to resolve the previously experienced alarm conditions and/or equipment unit problems. The system locates one or more possible corrective actions to remedy the alarm condition and/or problem from the corrective action database by comparing the equipment data to the plurality of records. Once identified, the electronic memo describing the possible corrective action is electronically transmitted to the end user.

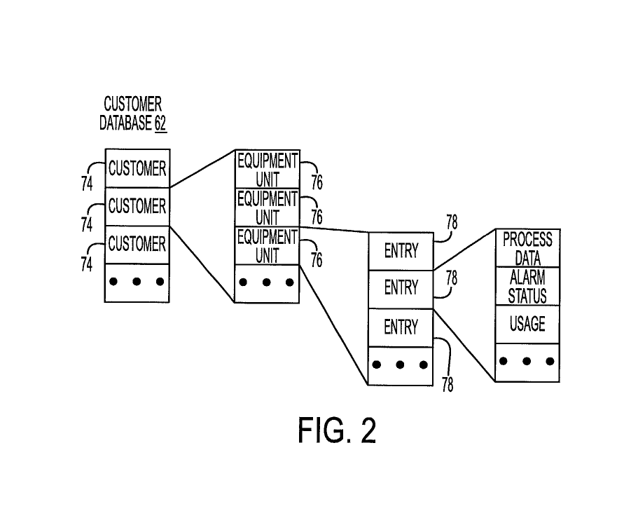

Directing attention to FIG. 2, customer database 62 has entries 74 for each customer being served, each of these entries essentially amounts to a sub-database for each customer. Each customer entry 74 has data fields 76 for each equipment unit, e.g., Trackmate™, Bulkmate·, Miniwastmate™, Wastemate™, and EnChem™. Each equipment unit data field 76 has multiple entries 78 that correspond to a process, an equipment usage or a commodity variable for that particular equipment unit or commodity. Each entry 78 may contain, for example, process data, alarm condition and the like which is representative of the equipment data. It will be recognized by the skilled artisan that customer database 62 may have many different structures and/or configurations without exceeding the scope of the present invention. Customer database 62, may serve as a library of information regarding an OEM's equipment, which would be based on actual use and supported by actual data from multiple end users of the equipment. Thus, customer database 62, may then be used to establish, for example and without limitation, additional databases correlating certain alarm conditions, the actual diagnosed problem and the solution thereto. Of particular advantage, the present invention provides the OEM with vast, real time data regarding the operation and condition of the equipment it supplies to its customers.

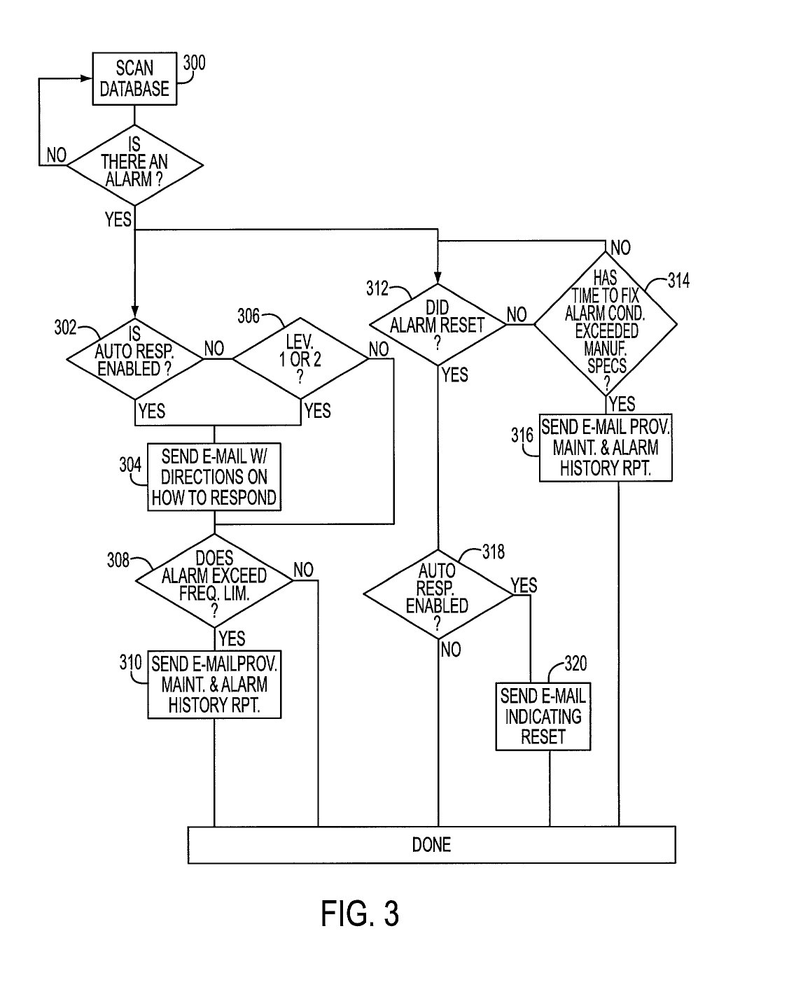

Referring to FIG. 3, one embodiment of the method of the present invention is provided. In step 300 of corrective action application 50 the real time data representative of the equipment data of the one or more equipment units in customer database 62 is scanned for an alarm condition. If no alarm condition exists the scanning step is continued. In step 302, if an alarm condition exists, it is determined if the customer has requested auto-response. A customer may want auto response only for certain elements of the production process, which request information could be stored in customer database 62 or in a separate database. In step 304, if auto response is enabled, an alert file containing directions on how to respond to the alarm condition is emailed to the customer. In step 306, if auto-response is not enabled, and the level of the alarm is level 1 or level 2 (on a scale of 3 with 1 being high), then preferably an alert file containing directions on how to respond to the alarm condition is emailed to the customer anyway. A level 1 or level 2 alarm would amount to a relatively serious failure and/or serious deviation within the process. In step 308, not withstanding the level of alarm or whether auto-response has been enabled, it is determined whether the frequency of the particular alarm condition, alone or in combination with the level of the particular alarm, is within OEM's specifications. The information necessary for this determination may be stored in customer database 62 or in a separate database. In step 310, if OEM's specifications for alarm frequency (alone or in combination with alarm levels) are exceeded, an email is sent to the customer providing a maintenance and alarm history report, which may contain such items as historical process data for a causation analysis.

In step 312 (beginning a quasi sub-routine), if an alarm condition exists, it is determined if the alarm was reset. In step 314, if the alarm is not reset, it is determined if the time for fixing the problem exceed OEM's specifications. In step 316, if OEM's specifications have been exceeded, an email is sent to the customer warning it of the condition and providing a maintenance and alarm history report and historical process data for causation analysis, after which this portion of the application terminates. If OEM's specification have not been exceeded, step 312 is repeated. In step 318, if the alarm has been reset, it is determined whether the customer has enabled auto response. In step 320, if auto response is enabled, an email is sent to the customer indicating that the alarm condition has been reset, after which this portion of the application is terminated.

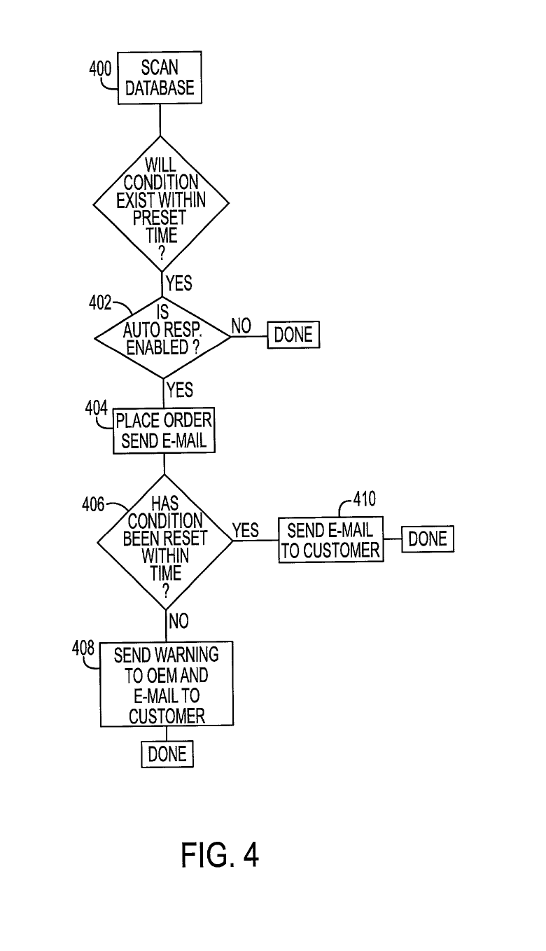

Of particular advantage, in an alternative embodiment of the present invention, the system and method assists in automated resource planning in addition to providing automated alarm notification and corrective action to end users. Specifically, the present invention may be used to indicate when operating supplies will be needed by the equipment units such as chemicals, various maintenance parts, and the like. Referring to FIG. 4, in step 400 of commodity and usage status application 72, the real time data in customer database 62, and/or other appropriate databases, is scanned to predict when low commodity or excess usage conditions will exist. As used herein, low commodity condition exists when the data indicate a particular commodity, e.g., photo resist, will need to be renewed. As used herein, an excess usage condition exists when a particular component, e.g. a valve or pump motor, will require preventative maintenance. In step 402, if a condition will exist within a preset time period, it is determined if the customer has requested auto-response. As discussed previously, a customer may want auto response only for certain elements of the production process. In step 404, if auto response is enabled, an order is placed for delivery of the commodity, and a file is emailed to the customer, which indicates that a commodity condition is anticipated, that replacement commodity has been ordered, and that delivery is expected by a certain date. In the case of usage conditions the order file would contain information that service personnel and/or a part will arrive by a particular date. In step 406, reset of the commodity or usage condition is monitored. In step 408, if reset of the condition has not occurred and the time from sending the email in step 404 exceeds a predetermined time (preferably the time indicated for delivery), a warning is sent to OEM personnel that the condition has not been reset, and an email is sent to the customer, which indicates that the condition has not been reset and that OEM personnel are looking into the situation. In step 410, if reset of the condition has occurred, an email message to that affect is sent to the customer. In this manner commodity and usage application 72 uses real time data to estimate when to order replacement commodity or preventative maintenance; thus, resulting in better inventory use and full use of equipment between preventative maintenance. As will be appreciated by the skilled artisan, some overlap exists between commodity and usage application 72 and corrective action application 50. While the redundancy is preferred, it is not required. It may be eliminated in several ways, one of which is to combine the operations of the applications.

The skilled artisan will recognize that a problem may trigger several different alarm, commodity, and/or usage conditions. As a simple example, an alarm condition that set point temperature has not been reached may be related to the alarm condition that the heating element also did not reach its set point temperature, and/or that the current flow through the heating element was too low, which in turn may be related to excess usage of the heating element. Thus preferably, alarm, commodity and/or usage conditions are correlated by corrective action application 50 and/or commodity and usage application 72. The correlation is then used to more specifically identify the problem and provide more specific instructions within the email responses to correct the problems.

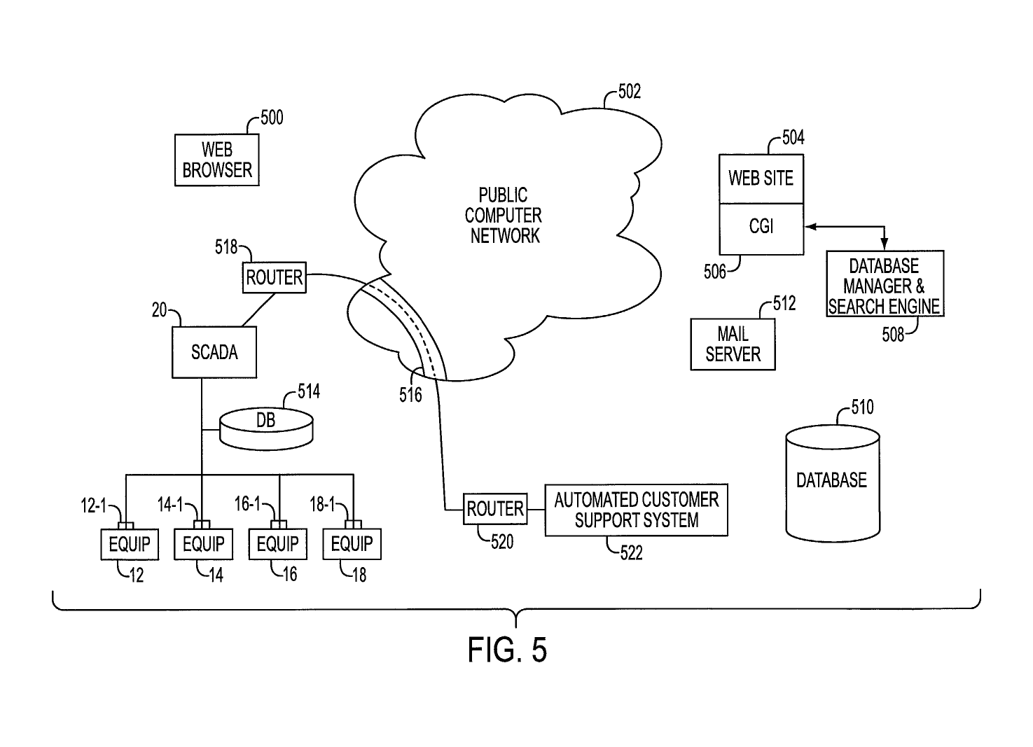

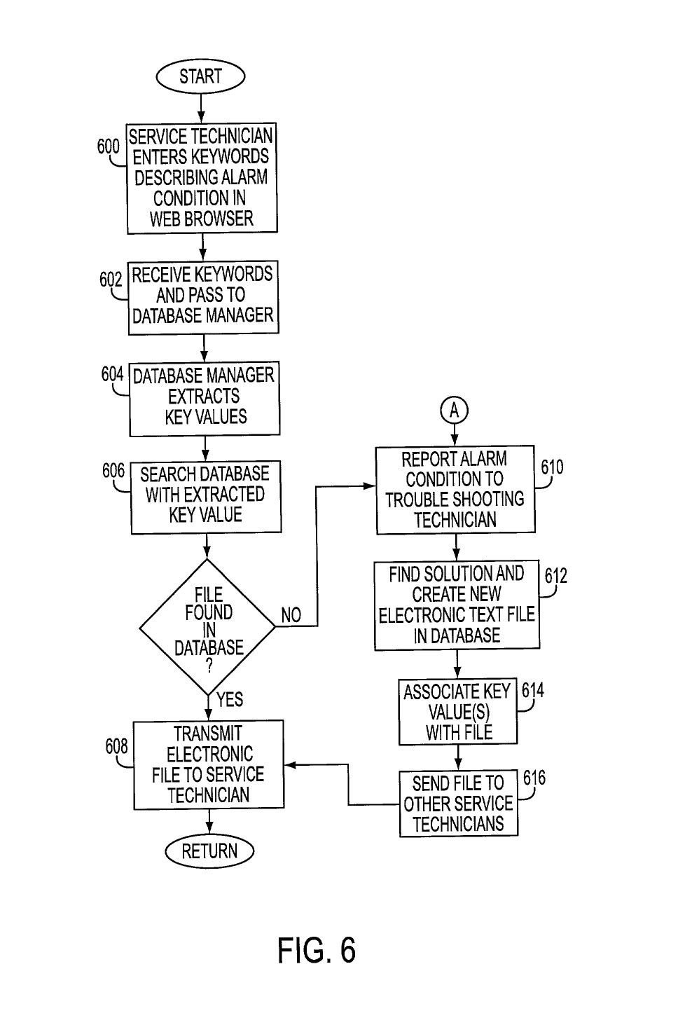

Directing attention to FIG. 5, an alternative embodiment of the architecture of the present invention is illustrated in block diagram form and is explained with references to flowchart diagram FIGS. 6-8. A service technician responsible for servicing semiconductor fabrication equipment at the customer site can utilize web browser 500 on a local desktop, laptop or other computer suitable for connection to public network 502, such as the Internet, to supply keywords describing the alarm condition (step 600). A web site 504, representing the customer support center 22, is connected to a common gateway interface (CGI) 506, and provides access to database manager 508. The web site 504 receives the key words from the service technician and passes them (step 602) through the CGI 506 to database manager 508. Using English language queries, consisting of keywords supplied by the service technician via web browser 500, database manager 508 extracts key values that are used to search database 510 (step 604). For instance, “fluid tank” and “valve won't close” can both be converted to numeric key values that represent specific problems experienced with manufacturing units 12, 14, 16 and 18. The database 510 can store a plurality of text files in electronic form that contain written instructions on how to solve a problem, or provide instructions to perform routine preventative maintenance on manufacturing equipment such as manufacturing units 12, 14, 16 and 18. If found, the electronic text file can be transmitted by the CGI 506 over the public computer network 502 to a service technician using the web browser 500, or mail server 512 may be utilized by the database manager 508 to send the electronic text file to the service technician as an attachment to an email message (step 608). However, if a file is not found in the database 510, the alarm condition can be reported to troubleshooting engineers (step 610) who can find a solution to the alarm condition, generate a new electronic text file that resolves the alarm condition, and store the new electronic text file in the database 510 (step 612) and associate it with the key values originally supplied by the service technician (step 614). In this manner, various diagnoses of the manufacturing units 12, 14, 16 and 18 can be developed, and provided to other service technicians at different manufacturing sites (step 616).

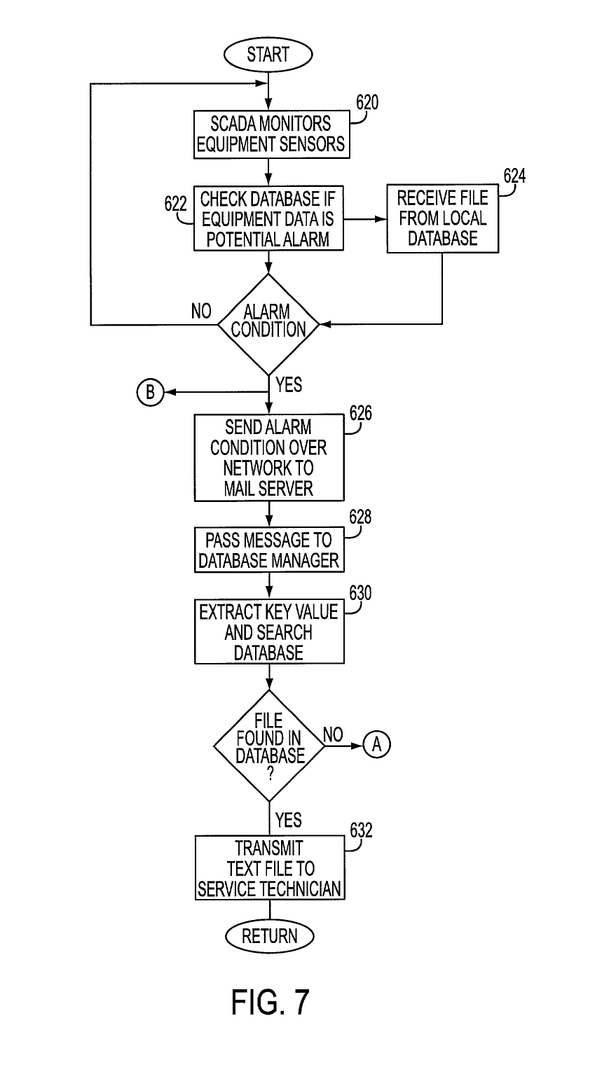

In a more automated embodiment of the present invention, SCADA 20 is in communication with manufacturing equipment such as manufacturing units 12, 14, 16, and 18, all having various sensors such as 12-1, 14-1, 16-1, 18-1 etc., attached to them that supply equipment data by monitoring the various operations performed by each piece of equipment (FIG. 7, step 620). For example, sensors can be used to verify that valves are opening and closing properly, how many hours the equipment has been in operation since its last service, temperature of various moving parts, volume flow, volume levels, and the like. The sensors are able to provide the SCADA 20 with equipment data. The SCADA 20 evaluates the equipment data by checking it against equipment data stored in its local database 514 (step 622), which may return an electronic text file explaining possible solutions to the alarm condition (optional step 624). Alternatively, if the local database 514 doesn't contain a text file addressing the condition described by the equipment data, it may return an electronic message that an alarm condition, as well as an indication of the nature of the alarm condition. For example, a key value may be returned that indicates an electronic message is created that contains an indication of the nature of the alarm condition. For example, if a sensor or equipment unit 12 conveys equipment data indicating that a particular valve has remained open throughout multiple cycles of a liquid storage tank, checking such equipment data against database 514 may indicate that there exists an alarm condition. The electronic message indicating an alarm condition is then sent over the public computer network 502 to the mail server 512 (step 626). The mail server 512 passes the message to the database manager 508 (step 628), which extracts a key value from the message and performs a search of database 510 using the extracted key value. Key values as referred to herein can be either key words such as those that indicate an individual piece of equipment, a particular equipment condition, such as “open valve,” and the like. Alternative, key values can also be numeric values that have a predetermined meaning, such as a numeric identifier for a particular piece of equipment or a numerical value identifying a particular equipment condition. Electronic text files that match the key values of the query can be transmitted to the service technician in the form of an email as described above (step 632). However, if there is no match, steps 610 through 616 can be performed as described above.

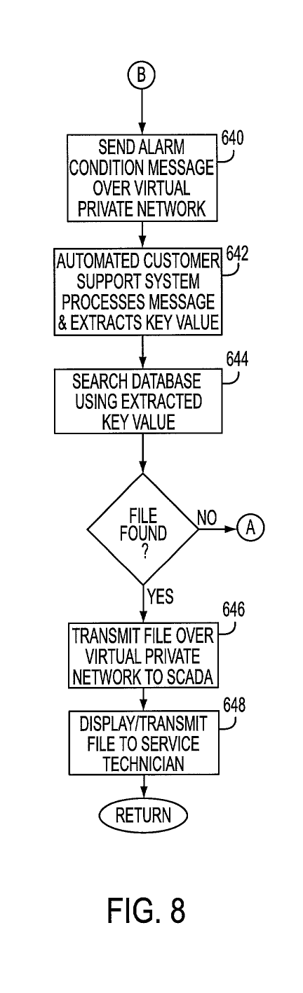

In an even more fully automated embodiment (FIG. 8), after executing steps 620 through 624 described above, the SCADA 20 can utilize a virtual private network 516, comprising reserved bandwidth within the public computer network 502, by passing equipment data and/or alarm conditions in the form of electronic messages over routers 518 and 520 to automated customer support system 522 (step 640). Automated customer support system 522 employs logic to extract key values from the electronic messages received over router 520 (step 642) and performs searches of the database 510 using the extracted key values (644). In a manner described above, electronic text files containing instructions for taking corrective action on the manufacturing equipment 12, 14, 18, and 19 can be retrieved from the database 510, and routed by the automated customer support system 522 over the virtual private network 516 to the SCADA 20 (step 646). The SCADA can then either display or transmit the electronic text file(s) to the service technician (step 648).

The SCADA 20, website 504, and automated customer support system 522 can each be configured to apply various rules based on customer information, such as frequency of occurrence of a particular alarm condition, time elapsed since alarm condition was reported, time elapsed since last preventative maintenance was performed, etc. to extract or modify key values. This additional logic allows a narrower search of the databases 510, 514 and potentially identifies the corrective action to be performed with a higher degree of accuracy.

In another aspect of the present invention, a method of conducting business is provided characterized in that equipment data, representative of the operation and use of manufacturing equipment units by a customer at a remote customer site is collected, monitored and stored by the manufacturer of the equipment at the manufacturers site, and selected information responsive to the equipment data is automatically transmitted to the customer by the manufacturer.

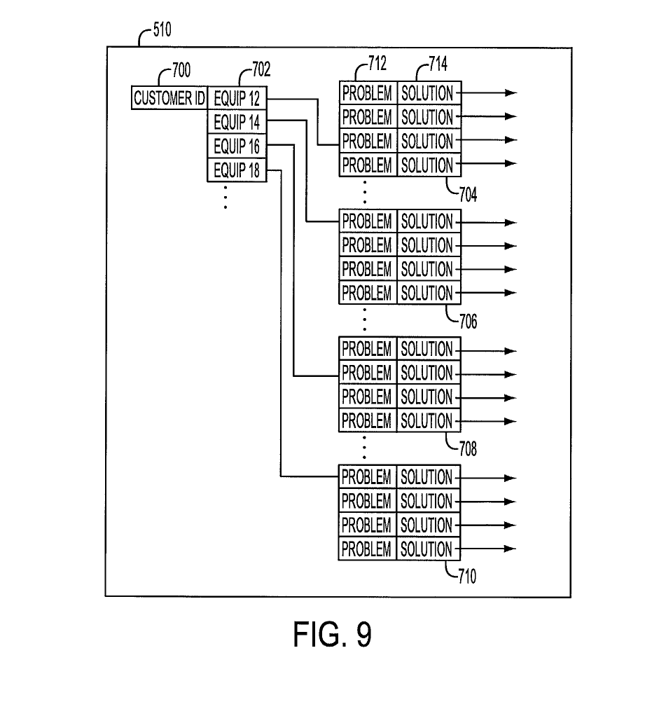

FIG. 9 shows a diagram of an embodiment of database 510. Database can include a customer identifier 700 that associates the known equipment 12, 14, 16, 18, etc., operating at the customer's site, with a series of problem key values 712 with pointers 714 to the electronic text files that contain instructions for corrective action to be taken by a service technician. The key values supplied to the database manager 506 or automated customer support system 522 are matched against the problem key values 712 of the database 510. Each problem key value is associated with a pointer that points to the physical storage location of the electronic text file containing instructions for corrective action is stored. When a key value matches a problem value 712, the database manager 506 or automated customer support system 522 retrieves the stored electronic text file from the referenced storage location. Alternatively, as described in steps 612 and 614, when no match is found, a trouble shooting engineer devises a solution to the new problem, creates a new electronic text file describing the solution, stores the electronic text file and creates a new problem key value 712/solution pointer 714 entry in the database 512. Depending on the business rules employed by the service provider, this new text file can be automatically transmitted to all known customers who deploy the equipment unit in which the newly resolved problem was experienced.

The foregoing description, for purposes of explanation, used specific nomenclature to provide a thorough understanding of the invention. Nevertheless, the foregoing descriptions of the preferred embodiments of the present invention are presented for purposes of illustration and description and are not intended to be exhaustive or to limit the invention to the precise forms disclosed; obvious modifications and variations are possible in view of the above teachings. Accordingly, it is intended that the scope of the invention be defined by the following claims and their equivalents.

What is claimed is:

1. A method of providing technical support to a service technician of semiconductor fabrication equipment, comprising the steps of:
receiving an alarm condition in the form of an electronic message, the electronic message including at least one key value associated with the alarm condition;
extracting the key value from the received message;
querying a database containing electronic text files using the extracted key value;
retrieving an electronic text file associated with a matching key value, the electronic text file describing procedural steps to be taken by the service technician to service semiconductor manufacturing equipment; and
transmitting the electronic text file to the service technician.

2. The method of claim 1, wherein the service involves preventative maintenance of the semiconductor fabrication equipment.

3. The method of claim 1, wherein the service involves repair of the semiconductor fabrication equipment.

4. The method of claim 1, further comprising the step of diagnosing a new condition if the step of querying the database yields no electronic text file having a matching key value.

5. The method of claim 4, further comprising the step of drafting a new written procedure that addresses the diagnosed new condition, associating at least one key value with the diagnosed new condition and storing the written procedure in the form of a new electronic text file in the database together with the associated key value.

6. The method of claim 5, further comprising the step of transmitting the new electronic text file to the service technician in the form of an email message over a public computer network.

7. The method of claim 1, wherein the alarm condition is identified and transmitted by supervisory control and data acquisition system that is in communication with a plurality of sensors placed on various pieces of semiconductor fabrication equipment.

8. The method of claim 1, wherein the alarm condition is identified and transmitted in the form of a text message by the service technician over a web browser connected to a public computer network.

9. A method of providing technical support to service technician who services semiconductor manufacturing equipment, the method comprising the steps of:
diagnosing a condition where service to the semiconductor manufacturing equipment is required;
drafting a written procedure for servicing the semiconductor manufacturing equipment in the form of an electronic text file;
storing the electronic text file in a database and associating the text file with at least one numeric key value, the associated key value representing the nature of the diagnosed condition;
receiving a request for service in the form of an electronic message sent over a public computer network from a service technician, the electronic message containing at least one key value that indicates the nature of the requested service;
extracting the key value from the electronic message;
querying the database using the extracted key value; and
if the extracted key value matches the associated key value then retrieving the electronic text file from the database and transmitting the electronic text message to the service technician over the public computer network.

10. The method of claim 9, wherein the alarm condition indicates a need for preventative maintenance of the semiconductor fabrication equipment.

11. The method of claim 10, wherein the service indicates a need for repair of the semiconductor fabrication equipment.

12. The method of claim 9, further comprising the step of diagnosing a new condition if the step of querying the database yields no electronic text file having a matching key value.

13. The method of claim 12, further comprising the step of drafting a new written procedure that addresses the diagnosed new condition, associating at least one key value with the diagnosed new condition and storing the written procedure in the form of a new electronic text file in the database together with the associated key value.

14. The method of claim 13, further comprising the step of transmitting the new electronic text file to the service technician over the public computer network.

15. A method of providing technical support to a service technician who services semiconductor manufacturing equipment, the method comprising the steps of:
diagnosing a condition where service to the semiconductor manufacturing equipment is required;
drafting a written procedure for servicing the semiconductor manufacturing equipment in the form of an electronic text file;
storing the electronic text file in a database and associating the text file with at least one numeric key value, the associated key value representing the nature of the diagnosed condition;
receiving a request for service in the form of an electronic message automatically generated by a supervisory control and data acquisition system that controls the semiconductor manufacturing equipment, the electronic message containing at least one key value that indicates the nature of the requested service;
extracting the key value from the electronic message;
querying the database using the extracted key value; and
if the extracted key value matches the associated key value then retrieving the electronic text file from the database and transmitting the electronic text file to the service technician over the public computer network.

16. A method of providing technical support to a service technician who services semiconductor manufacturing equipment, the method comprising the steps of:
diagnosing a condition where service to the semiconductor manufacturing equipment is required;
drafting a written procedure for servicing the semiconductor manufacturing equipment in the form of an electronic text file;
storing the electronic text file in a database and associating the text file with at least one numeric key value, the associated key value representing the nature of the diagnosed condition;
receiving a request for service in the form of an electronic message automatically generated by a supervisory control and data acquisition system that controls the semiconductor manufacturing equipment, the electronic message containing at least one key value that indicates the nature of the requested service;
extracting the key value from the electronic message;
querying the database using the extracted key value; and
if the extracted key value matches the associated key value then retrieving the electronic text file from the database and transmitting the electronic text file to other service technicians over the public computer network.

17. A computer program product containing instructions which, when executed by a computer, provide technical support to a service technician, by:
receiving an alarm condition in the form of an electronic message, the electronic message including at least one key value associated with the alarm condition;
extracting the key value from the received message;
querying a database containing electronic text files using the extracted key value;
retrieving an electronic text file associated with a matching key value;
transmitting the electronic text file to the service technician in the form of an email message.

18. A customer support system for semiconductor fabrication facilities utilizing semiconductor fabrication equipment, the system comprising:
a communication medium for receiving an electronic message from a supervisory control and data acquisition system, the semiconductor fabrication equipment and supervisory control and data acquisition system monitoring a plurality of sensors on semiconductor fabrication equipment and generating electronic messages in response to data received from the sensors, the electronic message indicating an alarm condition, the alarm condition indicating a need for service in a particular piece of semiconductor fabrication equipment and providing at least one key that represents the alarm condition, the key comprising a numerical value that characterizes the nature of the service, the communication medium connecting a technical support system with the supervisory control and data acquisition system;
a connection to a public computer network capable of delivering email messages;
a database storing portions of a technical service manual in the form of electronic text files, the electronic text files containing instructions to perform specific physical tasks that, when rendered, provide service to semiconductor fabrication equipment, the written portions being associated with at least one key;
a database management system for performing queries on the database by performing searches using the keys and retrieving the written portions of the technical service manual responsive to the performed queries, attaching the electronic text files to an email message and transmitting the email message via the public computer network to a service technician that perform service on the semiconductor fabrication equipment.

19. The customer support system of claim 18, wherein each of the electronic text files are associated with an order key that references the electronic text files in sequential order to form the service manual.

20. The customer support system of claim 18, wherein the database contains pointers, the pointers referencing physical storage locations of the electronic text files.
